(19) United States
(12) Patent Application Publication
(10) Pub. No.: US 2009/0052915 A1
(43) Pub. Date: Feb. 26, 2009

(54) CONSTANT VOLTAGE LEVELING DEVICE FOR INTEGRATED CHARGING SYSTEM

(75) Inventors: Alfred J. Claflin, JR., Ontario, NY (US); Jerry F. Adams, Waterport, NY (US); Susan A. Turner, Pittsford, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: XEROX CORPORATION, Stamford, CT (US)

(21) Appl. No.: 11/843,034

(22) Filed: Aug. 22, 2007

(51) Int. Cl. G03G 15/02

(52) U.S. Cl. 399/50; 399/171; 399/170; 399/172

(57) ABSTRACT

A charging system for uniformly charging an imaging surface moving in a predefined path including a dicorotron for charging the imaging surface; a discorotron, adjacent to and downstream from said dicortron, for charging the imaging surface; the discorotron including a coronode, a grid and a shield a first power supply for biasing the grid and the shield; a second power supply for energizing each of the coronode; means for determining a voltage level of the imaging surface and generating a feedback signal of the voltage level; and a controller, responsive to the feedback signal and in communication with the first power supply, for controlling the energiziation of the grid and the shield.

This invention relates generally to a corona generating device, and more particularly concerns a constant voltage leveling device for integrated charging system.

In a typical electrophotographic printing process, a photoconductive member is charged to a substantially uniform potential so as to sensitize the surface thereof. The charged portion of the photoconductive member is exposed to a light image of an original document being reproduced.

Exposure of the charged photoconductive member selectively dissipates the charges thereon in the irradiated areas. This records an electrostatic latent image on the photoconductive member corresponding to the informational areas contained within the original document. After the electrostatic latent image is recorded on the photoconductive member, the latent image is developed by bringing a developer material into contact therewith. Generally, the developer material comprises toner particles adhering triboelectrically to carrier granules. The toner particles are attracted from the carrier granules to the latent image forming a toner powder image on the photoconductive member. The toner powder image is then transferred from the photoconductive member to a copy sheet.

The toner particles are heated to permanently affix the powder image to the copy sheet.

In printing machines such as those described above, corona devices perform a variety of other functions in the printing process. For example, corona devices aid the transfer of the developed toner image from a photoconductive member to a transfer member. Likewise, corona devices aid the conditioning of the photoconductive member prior to, during, and after deposition of developer material thereon to improve the quality of the electrophotographic copy produced. Both direct current (DC) and alternating current (AC) type corona devices are used to perform these functions.

One form of a corona charging device comprises a corona electrode in the form of an elongated wire connected by way of an insulated cable to a high voltage AC/DC power supply. The corona wire is partially surrounded by a conductive shield. The photoconductive member is spaced from the corona wire on the side opposite the shield. An AC voltage may be applied to the corona wire and at the same time, a DC bias voltage is applied to the shield to regulate ion flow from the corona wire to the photoconductive member being charged.

Another form of a corona charging device is pin corotrons and scorotrons. The pin corotron comprises an array of pins integrally formed from a sheet metal member that is connected by a high voltage cable to a high power supply. The sheet metal member is supported between insulated end blocks and mounted within a conductive shield. The photoconductive member to be charged is spaced from the sheet metal member on the opposite side of the shield. The scorotron is similar to the pin corotron, but is additionally provided with a screen or control grid disposed between the coronode and the photoconductive member. The screen is held at a lower potential approximating the charge level to be placed on the photoconductive member. The scorotron provides for more uniform charging and prevents overcharging.

Still other forms of corona charging devices include a dicorotron. The dicorotron comprises a coronode having a conductive wire that is coated with an electrically insulating material. When AC power is applied to the coronode by way of an insulated cable, substantially no net DC current flows in the wire due to the thickness of the insulating material. Thus, when the conductive shield forming a part of dicorotron and the photoconductive member passing thereunder at the same potential, no current flows to the photoconductive member or the conductive shield. However, when the shield and photoconductive member are at different potentials, for example, when there is a copy sheet attached to the photoconductive member to which toner images have been electrostatically transferred thereto, an electrostatic field is established between the shield and the photoconductive member which causes current to flow from the shield to the ground.

In a highlight color machine (HCL) capable of producing 100 or more images per minute, such as the DT 128/155/180 HLC® manufactured by Xerox, requires a charging device capable of delivering uniform charging performance during high speed imaging. Significant challenges include a process velocity of 753 mm/sec with limited control of belt flatness spanning between black development and the backer bar after the HLC recharge device.

The present invention obviates the problems noted above by providing a charging system for uniformly charging an imaging surface moving in a predefined path including a dicorotron for charging the imaging surface; a discorotron, adjacent to and downstream from said dicortron, for charging the imaging surface; said discorotron including a coronode, a grid and a shield a first power supply for setting said grid and said shield to zero current; a second power supply for adjusting said shield voltage; a third power supply for energizing each of said coronode; means for determining a voltage level of said imaging surface and generating a feedback signal of said voltage level; and a controller, responsive to said feedback signal and in communication with said first power supply, for controlling the energization of said grid and said shield.

Other aspects of the present invention will become apparent as the following description proceeds and upon reference to the drawings, in which:

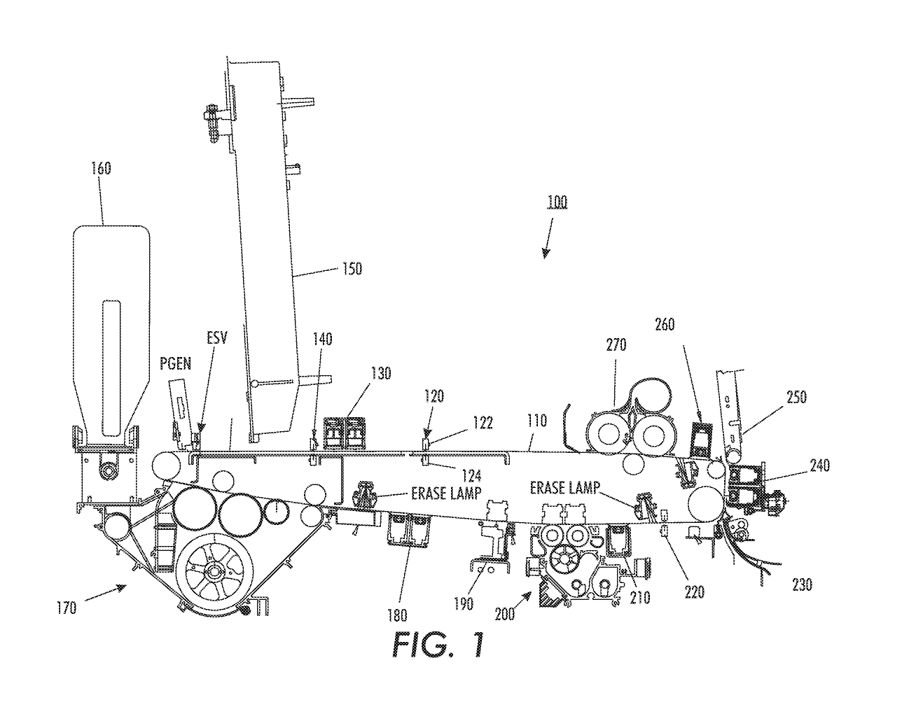

FIG. 1 is an illustration of a charging system useful in the printer apparatus; and

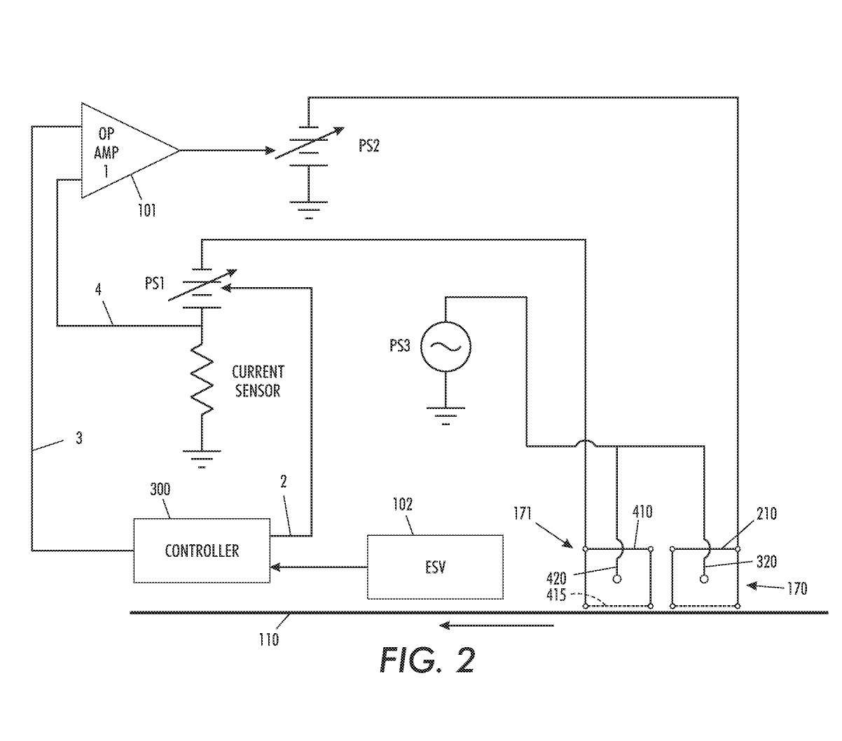

FIG. 2 is a schematic elevational view depicting an illustrative high speed color electrophotographic printing machine incorporating the apparatus of the present invention therein.

While the present invention will hereinafter be described in connection with a preferred embodiment, it will be understood that it is not intended to limit the invention to that embodiment. On the contrary, it is intended to cover all alternatives, modifications and equivalents as may be included within the spirit and scope of the invention as defined by the appended claims.

For a general understanding of the features of the present invention, reference is made to the drawings. In the drawings, like reference numerals have been used throughout to designate identical elements. Referring initially to FIG. 2, there is shown an exemplary color image forming device 100. The color image forming device 100 of FIG. 2 may be a highlight color image forming device that applies a highlight color, in addition to black, to a recording medium such as paper. The image forming device 100 may apply charge substantially uniformly across a photoconductive belt 110, using a charging unit 130 of the present disclosure. The photoconductive belt 110 may then travel past an exposure unit that may include a raster output scanner (ROS) 150 that may irradiate the photoconductive belt 110 according to a pattern which corresponds to the data of the document elements which are to be black in color. The exposed photoconductive belt 110 may then travel past a black developing unit 170 that may deposit black toner particles onto the photoconductive belt 110. The black toner particles may adhere electrostatically to the charged areas of the photoconductive belt 110, but may not adhere to the uncharged areas.

The photoconductive belt 110 may then travel past another charging unit 180, which may again apply a substantially uniform charge across the photoconductive belt 110. The charged photoconductive belt 110 may then travel past a color exposing unit 190 that may contain light emitting diodes, for example, which may irradiate the surface of the photoconductive belt 110 according to the occurrence of color elements in the document. The exposed photoconductive belt 110 may then travel past a color developing unit 200 that may deposit color toner particles on the photoconductive belt 110. The color toner particles may adhere electrostatically to the charged areas of the photoconductive belt 110, but may not adhere to the uncharged areas.

The raster output scanner 150 and the color exposing unit 190 may irradiate the photoconductive belt 110 with a halftone pattern appropriate for image forming device 100. The output of image forming device 100 may consist of a number of halftone cells, each of which includes a number of printed dots. For example, printing a 75 lines per inch halftone grid on a 600 dots-per-inch laser printer produces a halftone cell that is 600/75=8 pixels wide, for a total cell size of 8×8 or 64 laser printer dots. Shades of gray may be provided by varying the size or frequency of the printer dots within the halftone cell.

For example, for image forming device 100 to output areas corresponding to black, raster output scanner 150 may irradiate the photoconductive belt 110 with a series of dots with size or frequency of occurrence determined by the blackness of the output to be rendered. Similarly, exposing unit 190 may irradiate the photoconductive belt 110 with a series of dots with size or frequency of occurrence determined by the brightness of the color to be rendered.

The photoconductive belt 110 may thus contain black and color toner particles in areas corresponding to the black and color areas of the document. The toner may be transferred to a recording medium in a transfer unit. A sheet of the recording medium, such as paper, may be taken from a paper supply 230. The backside of the sheet of paper may be charged by a charging unit 240, and the charged paper may then attract the toner particles from the photoconductive belt 110. The toner particles may adhere to the sheet of paper electrostatically. The paper may then be separated from the photoconductive belt 110 and transferred to a fixing unit 250, which may heat the paper to fuse the toner particles to the paper. The paper may then be directed to an output bin (not shown).

The photoconductive belt 110 may be provided with a plurality of holes that may be detected by belt hole sensors 120, 140 and 220. The belt hole sensors 120, 140 and 220 may use, for example, a light source 122 that shines light against the photoconductive belt 110. The belt hole sensors 120, 140 and 220 may detect passage of the holes by detecting the light transmitted through the belt holes onto a detector 124 located on the other side of the photoconductive belt 110. The belt hole sensors 120, 140 and 220 may thereby detect stretching or other unexpected displacements of the photoconductive belt, and adjust timing of the exposure units 150 and 190 to accommodate such variables.

Turning now to FIG. 1 is illustrated configurations of charging system useful in the printer apparatus of FIG. 2. Charging device 1302 utilize dicorotron 170 and a discorotron 171 adjacent to and downstream from the dicortron 170. Dicorotron 170 includes a coronode member which is preferably a wire 320 and shield 210. Discorotron 171 includes a coronode member which is preferably a wire 420, shield 410 and grid 415.

The charging system includes a power supply controller 300 to actuate and monitor two power supplies PS1, and PS2 which in turn respectively drive and control the shield current, shield voltage and grid voltage for dicorotron and discorotron. Controller 300 may be either software or hardware derived. Controller 300 employs digital values corresponding to the power supply actuation levels. The digital values arrived at are converted by a digital to analog (D/A) converter for use in controlling the output of the power supplies. Target values for use in setting and adjusting the operation of the power supplies are provided by a system controller in accordance with system operational requirements.

In operation, the high voltage power supply controller periodically polls the shield current monitors. If these monitor signals meet the criteria established (too high or too low) the high voltage power supply controller would then adjust the shield voltage analog control. This is an iterative process. The next polling of the shield current monitors is used to further refine the shield voltage setting, etc. The various analog monitors and controls are made available to the system controller. The discorotron device acts as a feedback and charge-leveling device within the ICS. A target voltage is established via NVM setting. The photoconductive belt will pass beneath the first charging device, i.e. dicorotron, where a copious amount of charge is deposited on the belt surface in order to attain the desired target voltage. The second charging device, i.e. discorotron, acts as a feedback device in order to maintain the NVM set point requirement of zero current on the shield (PS1) (in standard dicorotron device operation, the shield current is equal to the photoconductive belt current). Power supply PS1) delivers a current between 0 and 20 uA.

This is accomplished via an AC voltage (PS3) applied on the dielectric coated wire and providing a DC shield potential that drive charges of same polarity to the photoconductive belt. Power supply (PS1) applies a bias between −5000 and −7000 V RMS The ESV reads the voltage of photoconductive belt (Signal 1) and provides the voltage to the controller. The outputs (Signal 3) from the controller provides the target voltage input to the OP Amp 101 where the comparator ensures that the zero shield current requirements (Signal 4) is maintained by adjusting the shield voltage of charge 1 dicorotron (PS2) to achieve the target voltage requirement. Power supply (PS2)applies a bias between −500 and −2000 V DC The other output (Signal 2) from the same controller, will adjust PS1 accordingly to maintain the desired current to achieve the voltage read by the ESV 102. The grid of the charge discorotron serves to provide more uniform voltage leveling of the photoconductive belt and therefore significantly better print quality due to better interaction with the hybrid scavenged developed (HSD) image downstream of the photoconductive belt path.

IApplicants have found utilizing a discorotron as the second charging device instead of a dicorotron provides a significant improvement in the voltage uniformity and hence, half tone macro uniformity as a result of better HSD development within a discharged area development (DAD) scheme for highlight color (HLC). The discorotron screen or grid is set to zero current instead of the shield as is used within a dicorotron. The resulting field between grid and photoreceptor is more uniform and acts to level the previously charged surface despite belt flatness or other gap variations within the present architecture prior to imaging with the LED bar. This invention provides a significant print quality improvement within the same footprint of space as the existing embodiment. Other schemes to improve charging uniformity often require additional coronodes and therefore a larger footprint.

It is, therefore, apparent that there has been provided in accordance with the present invention, a charging apparatus which fully satisfies the aims and advantages hereinbefore set forth. While this invention has been described in conjunction with a specific embodiment thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A charging system for uniformly charging an imaging surface moving in a predefined path comprising,
a dicorotron for charging the imaging surface;
a discorotron, adjacent to and downstream from said dicortron, for charging the imaging surface; said discorotron including a coronode, a grid and a shield;
a first power supply for controlling said shield current;
a second power supply for biasing said shield;
a third power supply for energizing each of said coronode;
means for determining a voltage level of said imaging surface and generating a feedback signal of said voltage level; and
a controller, responsive to said feedback signal and in communication with said first power supply, for controlling the energiziation of said grid and said shield.

2. A charging system of claim 1, wherein said controller energizing of said grid and said shield to either acts to add or to subtract charge laid down by said dicorotron in response to said feedback signal.

3. A charging system of claim 1, further comprising a third power for biasing said dicortron.

4. A charging system of claim 1, wherein said determining means is an ESV for measuring voltage potential of the imaging surface.

5. A charging system of claim 1, wherein said first power supply controls a current between x and y 0 and 20 uA.

6. A charging system of claim 1, wherein said second power supply applies a bias between x and y −500 and −2000 V DC.

7. A charging system of claim 1, wherein said third power supply applies a bias between x and y −5000 and −7000 V RMS.
